(19) United States
(12) Patent Application Publication
(10) Pub. No.: US 2013/0011231 A1
(43) Pub. Date: Jan. 10, 2013

(54) APPARATUS AND METHOD FOR LIFTING A WHEELCHAIR

(76) Inventor: Daniel R. Tekulve, Batesville, IN (US)

(21) Appl. No.: 13/635,229

(22) PCT Filed: Mar. 15, 2011
(86) PCT No.: PCT/US2011/028574

§ 371 Date: Sep. 14, 2012

Related U.S. Application Data
(60) Provisional application No. 61/313,802, filed on Mar. 15, 2010.

(51) Int. Cl. A61G 5/14

(52) U.S. Cl. 414/495; 254/418; 414/812

(57) ABSTRACT

An apparatus for lifting a wheelchair, the wheelchair including a frame with first and second rear frame members and first and second front frame members, the apparatus including a ground-engageable base; a chair connection assembly having connection means for securely connecting to the frame of a wheelchair; a lift assembly having first and second lift members, the first lift member connected with the chair connection assembly and the second lift member connected to the base; power means connected with the lift assembly for moving the lift assembly between a retracted, down position and an extended, up position; and a lift control assembly for connecting the power means with the lift assembly and for controlling the lift assembly.

### REFERENCE TO RELATED APPLICATIONS

This application claims priority from U.S. Provisional Application No. 61/313,902 filed Mar. 15, 2010, which application is hereby incorporated by reference in its entirety.

### FIELD OF THE INVENTION

The present invention relates to the field of health care devices, and more specifically, to an apparatus for lifting an occupied wheelchair to assist the occupant of in exiting the wheelchair.

### BACKGROUND OF THE INVENTION

Wheelchairs are wheeled mobility devices used by people for whom walking is difficult or impossible. For many, the very illness, injury or disability that creates the need for a wheelchair often signals a corresponding difficultly in the occupant getting out of the wheelchair. Obesity and lack of physical strength may further complicate the matter. Some people may simply be unable to stand and exit the chair without outside assistance, and even that can be extremely difficult given the inherently awkward and cumbersome nature of leaning over and lifting a person, whether light or heavy, to a standing position. What is needed is an apparatus to assist a wheelchair occupant in rising from the seated to a standing position.

### SUMMARY OF THE INVENTION

Generally speaking, a device is provided to a wheelchair in a non-linear path the moves the chair up, and rearwardly and rocks the chair forward to facilitate exiting the chair.

An apparatus for lifting a wheelchair, the wheelchair including a frame with first and second rear frame members and first and second front frame members, the apparatus including a ground-engageable base; a chair connection assembly having connection means for securely connecting to the frame of a wheelchair; a lift assembly having first and second lift members, the first lift member connected with the chair connection assembly and the second lift member connected to the base; power means connected with the lift assembly for moving the lift assembly between a retracted, down position and an extended, up position; and a lift control assembly for connecting the power means with the lift assembly and for controlling the lift assembly.

It is an object of the present invention to provide a device to lift and/or tilt a wheelchair.

Further objects and advantages of the present invention will become apparent from the following description of the preferred embodiment.

### BRIEF DESCRIPTION OF THE DRAWINGS

FIG. 1 is a side, elevational view of an apparatus 10 for lifting a wheelchair 5 in accordance with the present invention and shown mounted to a wheelchair 5 and in the retracted, down position.

FIG. 2 is a front view of the apparatus 10 for lifting a wheelchair 5 of FIG. 1 and shown mounted to a wheelchair 5.

FIG. 3 is a perspective view of the apparatus 10 for lifting a wheelchair 5 of FIG. 1.

FIG. 4 is a side, elevational view of the apparatus 10 for lifting a wheelchair 5 of FIG. 1 and shown mounted to a wheelchair 5, without front, right wheel 24, and shown in the extended, up position.

FIG. 5 is a perspective view of the wheelchair 5 and apparatus 10 for lifting a wheelchair 5 of FIG. 4 and shown in the extended, up position.

FIG. 6 is a side view of the apparatus 10 for lifting a wheelchair 5 of FIG. 1 and in the retracted, down position 75.

FIG. 7 is front view of just the apparatus 10 for lifting a wheelchair 5 of FIG. 3.

FIG. 8 is a side, cross-sectional view of the apparatus 10 for lifting a wheelchair 5 of FIG. 1 taken along the lines 8-8 of FIG. 7 and viewed in the direction of the arrows and in the retracted, down position 75.

FIG. 9 is side, cross-sectional view of the apparatus 10 for lifting a wheelchair 5 of FIG. 8 and in the extended, up position 76.

FIG. 10 is an enlarged view of the upper guide assembly 79 of the movement assist elements of the apparatus 10 for lifting a wheelchair 5 of FIG. 8.

FIG. 11 is an electrical diagram showing the circuitry of the apparatus 10 for lifting a wheelchair 5 of FIG. 1.

FIG. 12 is side view of the apparatus 10 for lifting a wheelchair 5 of FIG. 1 and in the retracted, down position 75.

FIG. 13 is a cross-sectional view of the apparatus 10 for lifting a wheelchair 5 of FIG. 12 taken along the lines 13-13 of FIG. 7 and viewed in the direction of the arrows.

FIG. 14 is an enlarged view of the end cap 196 and rod 189 of the apparatus 10 of FIG. 13.

### DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, and any alterations and modifications in the illustrated device, and further applications of the principles of the invention as illustrated therein are herein contemplated as would normally occur to one skilled in the art to which the invention relates.

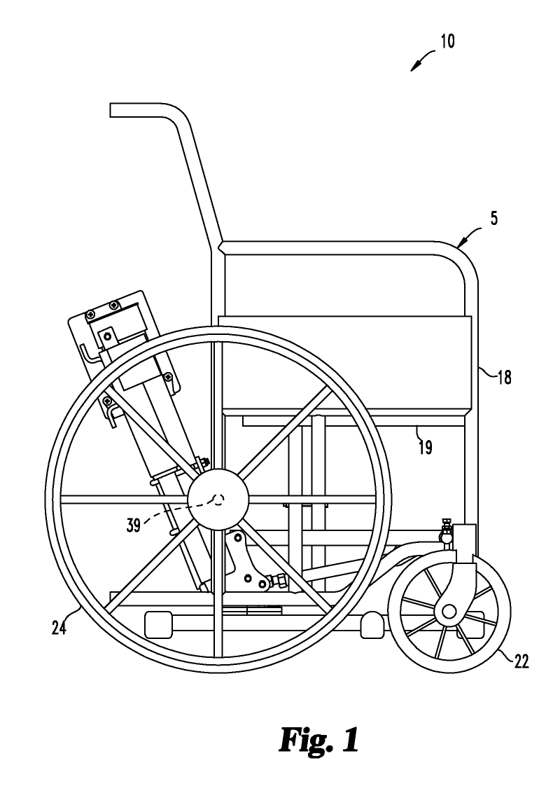

Referring to FIGS. 1-4, there is shown an apparatus 10 for lifting a wheelchair 5 in accordance with the present invention. Apparatus 10 generally includes a base 11, a lift assembly 12, a chair connection assembly 13, a power source 14 and a lift control assembly 15.

A basic standard, manual wheelchair, such as the one shown in FIGS. 1, 2, 4 and 5, includes a frame 18, a seat 19, a back 20, two small front (caster) wheels 21 and 22, and two large rear wheels 23 and 24. While there are often many variations of the wheelchair design, a significant percentage are of the folding variety shown in FIGS. 1, 2 and 4. This type of wheelchair has a generally tubular construction frame with left and right, rear vertical frame members 27 and 28, left and right, lower frame members 29 and 30, and crisscrossing frame members 31 and 32. The crisscrossing frame members 31 and 32 are pivotally connected at a pin 35, which allows the wheelchair to be collapsed into a narrower, storage profile (not shown), but also creates a gap 36 between crisscrossing members 31 and 32 and ground 33. The left and right, rear vertical frame members 27 and 28 hold coaxial axles 38 and 39 for wheels 23 and 24, respectively, but there are portions of unobstructed vertical frame, above or below these axles (i.e. at 40), to which a clamping structure can be applied, as described herein. And left and right, lower frame members 29 and 30 have opposing portions 41 and 42, proximal the chair front, that are relatively horizontal and generally mutually parallel.

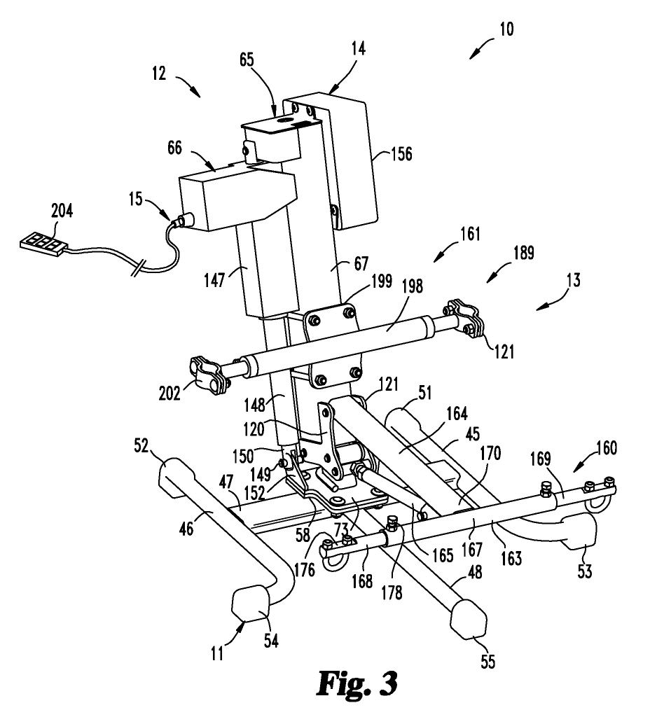

Referring to FIG. 3, base 11 comprises opposing left and right, minor image outer arms 45 and 46, a cross member 47 extending between and rigidly connecting arms 45 and 46 to each other to form an “H” configuration, and a central arm 48 rigidly connected to cross member 47, roughly midway between arms 45 and 46 and extending therefrom forwardly, initially parallel to and farther forward of outer arms 45 and 46, as shown in FIG. 3. Outer arms 45 and 46 each extend rearwardly of cross member 47, terminating in (first and second) rear feet 51 and 52. Outer arms 45 and 46 each extend forwardly of cross member 47 a short distance where they each turn outwardly, away from each other, terminating in left and right (first and second) forward feet 53 and 54. And at its outboard, forward end, central arm terminates in a central front foot 55. Feet 51-55 are thus rigidly connected together, define a generally pentagonal base for apparatus 10, and are configured for co-planar engagement with ground 33 (that is, any lower surface upon which apparatus 10 is disposed). To strengthen the interconnection of cross member 47 and central arm 48 and to facilitate assembly, a central base plate 58 is rigidly connected (as by welding or other suitable manner) to cross member 47 and central arm 48, as shown. Arms 45, 46 and 48 and cross member 47 comprise steel tubing, but other materials and/or configurations are contemplated, so long as the feet 51-55 form a strong support base and are juxtaposed in the position shown and described here.

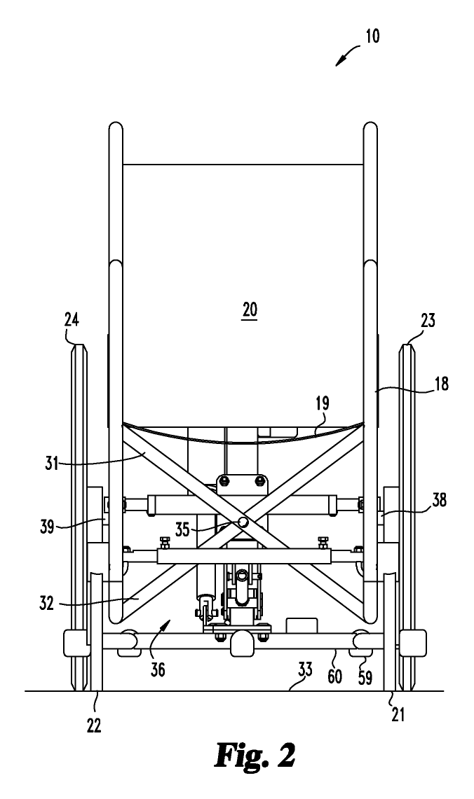

Feet 51-55 generally comprise the distal ends of arms 45, 46 and 48, which have been bent, shaped, enlarged and/or covered so that each presents a lower foot surface (as at 59, FIG. 2) that is lower than the bottoms (as at 60) of arms 45, 46 and 48, themselves. Thus, the lower surfaces (59) of feet (51-55) are mutually co-planar and below the rest of arms 45, 46 and 48 so that it is the five feet 51-55 that engage the ground, and not any part of the rest of arms 45, 46 and 48 (unless, of course, the ground below apparatus 10 is not perfectly flat).

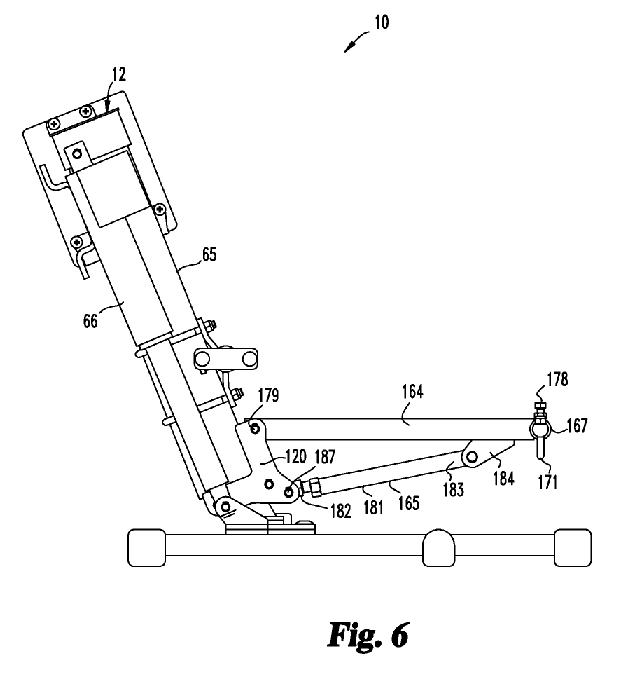

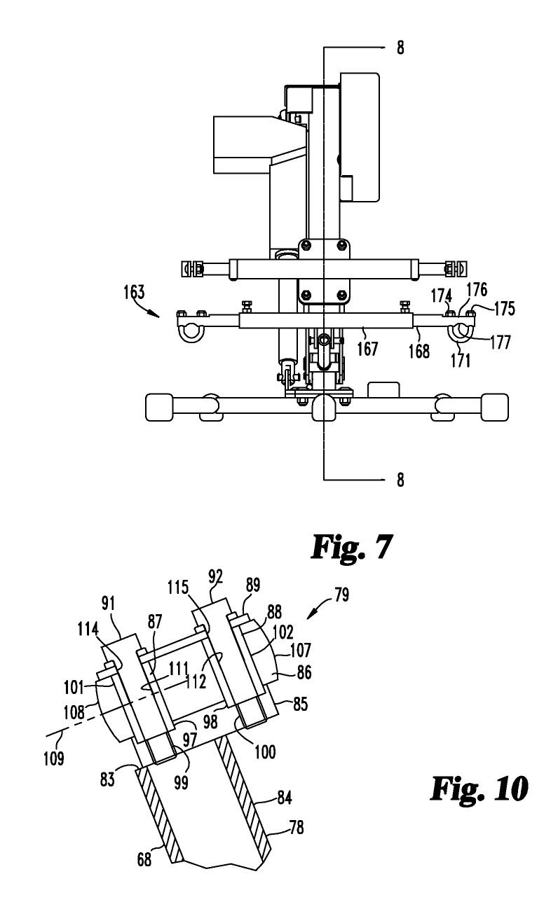

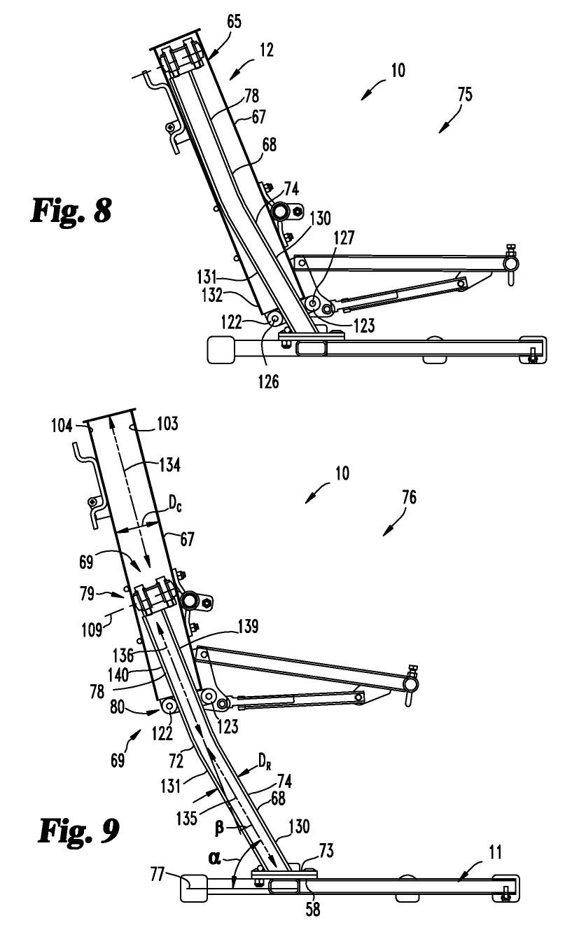

Referring to FIGS. 3 and 6-9, lift assembly 12 includes a guide assembly 65 and a motive assembly 66. Guide assembly 65 is a non-linear movement, rod within-a-sleeve combination, and generally includes a sleeve 67 (a first lift member), a rod 68 (a second lift member) and movement assist elements 69 interposed therebetween, as desired and appropriate. Sleeve 67 is a straight, rectangular cross-sectioned tube and has a clearance dimension D_{C} in the X-Y plane (of FIG. 9). Rod 68 is also a tube, having a generally rectangular cross-section and a rod dimension D_{R}; but rod 68 it is not straight. Rather, it is bent at a transition angle β at about its midpoint (also a transition point at 72), as shown, thus defining a lower portion 74 and an upper portion 78. Transition angle β is between about 6 and 10 degrees, with a preferred transition angle β of about 8 degrees. At its bottom, rod 68 is fixed as by welding to a mounting plate 73, which is rigidly secured (as with bolts) to central base plate 58 of base 11. The structures comprising rod 68, plates 73 and 58, and base 11, and their mutual interconnections, are configured such that the lower portion 74 of rod 68 forms a lift angle α with a plane 77 defined by mutually coplanar feet 51-55. In one embodiment, lift angle α is between about 53 and 67 degrees, and preferably about 60 degrees. With its bend (at 72), rod 68 is configured to reciprocate within sleeve 67 between a retracted, down position 75 (FIG. 8) and an extended, up position 76 (FIG. 9). To accommodate this reciprocation with bent rod 68, the clearance dimension D_{C} is sufficiently greater than the corresponding rod dimension D_{R} so as to permit rod 68 to be substantially entirely received within sleeve 67 in the retracted, down position 75, as shown.

Movement assist elements 69 include an upper guide assembly 79 and a lower guide assembly 80. Upper guide assembly 79 is connected to the top 83 of rod 68 and slidingly engages the inside of sleeve 67 to act as the follower for the top end 84 of rod 68. Upper guide assembly 79 includes a plate 85, a guide block 86, bushings 87 and 88, a top plate 89, and bolts 91 and 92. Plate 85 is metal, is welded to rod top 83, and defines a pair of circular recesses 97 and 98 and smaller, deeper and threaded recesses 99 and 100 that are coaxial with recesses 97 and 98, respectively. Guide block 86 is generally rectangular, defines a pair of through holes 101 and 102 that align with recesses 97 and 98 and is made of Nylon, Delrin, polyethylene, or any appropriate material that facilitates sliding engagement between it and the inner opposing side walls 103 and 104 of sleeve 67. The opposing front and rear sides 107 and 108 of guide block 86 are arcuate to accommodate a degree of pivot of the planar axis 109 of guide block 86 relative to the planar walls 103 and 104 of sleeve 67 as it moves between the retracted, down position 75 and the extended, up position 76. In one embodiment, the curvature of sides 107 and 108 is such that sides 107 and 108 are substantially tangent to walls 103 and 104 at the points (or lines) of engagement as block 86 moves between positions 75 and 76.

Bushings 87 and 88 are also nylon (or Delrin or any appropriate material) and define central holes 111 and 112, respectively. Top plate 89 defines holes 114 and 115 that align with holes 101 and 102, respectively, of guide block 86. Upper guide assembly 79 is assembled as shown in FIG. 10, with block 86 positioned atop plate 85, with bushings 87 and 88 disposed in through holes 101 and 102 and into recesses 97 and 98, with top plate 89 positioned atop block 86, and with bolts 91 and 92 extending through holes 114 and 115, 111 and 112 and being threadedly received within holes 99 and 100, respectively, to clamp top plate 89, block 86, bushings 87 and 88 and plate 85 tightly together. Plate 85 is fixed to guide top 83, offset from center, as shown in FIG. 10 such that when rod 68 is in the retracted, down position 75, and upper guide assembly 79 is inherently centered between the forward and rearward walls 103 and 104 of sleeve 67, the top end 84 of rod 68 is positioned very near, but preferably not in contact with the rear wall 104 of sleeve 67, as shown in FIG. 8.

Referring to FIGS. 3, 8 and 9,at the bottom of sleeve 67, lower guide assembly 80 includes a pair of bracket plates 120 and 121 rigidly fixed on opposing left and right sides thereof and guide rollers 122 and 123, each mounted for rotation to bracket plates 120 and 121 by axles 126 and 127. The rollers 122 and 123 are mounted to sleeve 67 to rollingly engage the outer, front and rear walls 130 and 131 of rod 68 to act as the follower for the bottom end of sleeve 67.

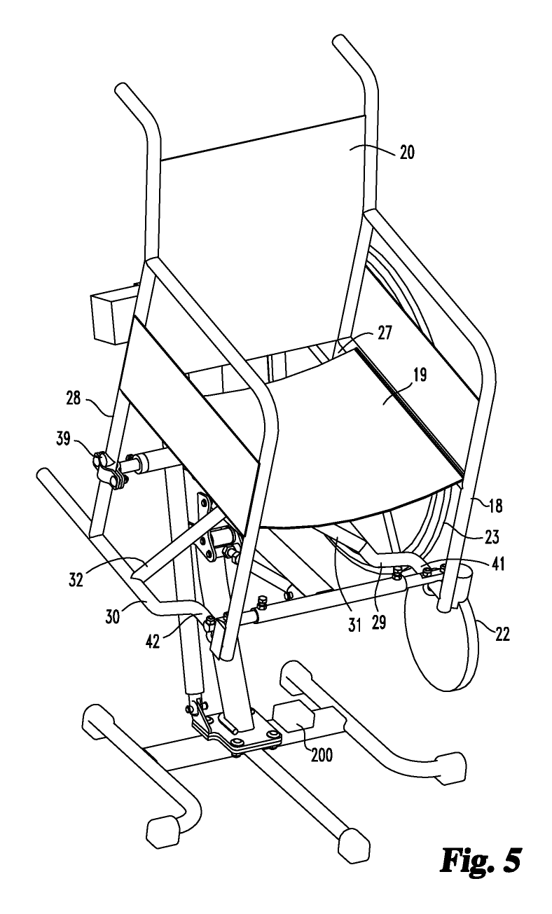

In operation, as sleeve 67 is moved upwardly from the retracted, down position 75, upper and lower guide assemblies 79 and 80 connected with rod 68 and sleeve 67, respectively, follow the three different follower lines 134, 135 and 136 of sleeve 67, lower portion 74 and upper portion 78, respectively. Follower line 134 is a vector line parallel to the parallel inner walls 103 and 104 of sleeve 67; follower line 135 is a vector line parallel to the parallel outer rod surfaces 130 and 131 of lower portion 74 of rod 68; and follower line 136 is a vector line parallel to the parallel outer rod surfaces 139 and 140 of upper portion 78 of rod 68. Follower lines 135 and 136 indicate the direction of travel of lower guide assembly along rod 68. Follower line 134 indicates the direction of travel of upper guide assembly 79 along and inside sleeve 67. As upper and lower guide assemblies 79 and 80 move along their respective follower lines 134, 135 and 136, upper guide assembly 79 moves along follower line 134, and lower guide assembly 80 (rollers 122 and 123) moves along follower line 135. Because follower lines 134 and 135, in the retracted, down position 75 (FIG. 8) are both inclined rearwardly and are not mutually coaxial or parallel (in the embodiment and down position 75 shown in FIG. 8, upper portion 78 of rod 68 is generally parallel to sleeve 67, and their follower lines 134 and 135 form roughly the same angle as the transition angle β between follower lines 135 and 136) sleeve 67 (and a wheelchair held thereby, as described herein) initially moves up and rearwardly and rocks forwardly, in one embodiment about 8 degrees, as shown in FIGS. 5, 8 and 9. Once rollers 122 and 123 hit transition point 72 of rod 68, they and the lower end 132 of sleeve 67 begin moving along the upper follower line 136. Because upper follower line 136 and the follower line 134 of sleeve 67 are still inclined rearwardly and are not mutually coaxial or parallel, sleeve 67 (and the wheelchair held thereby) moves still up and rearwardly, and rocks forwardly somewhat. As shown in FIG. 9, rollers 122 and 123 are offset slightly forwardly from their position at the bottom end of sleeve 67.

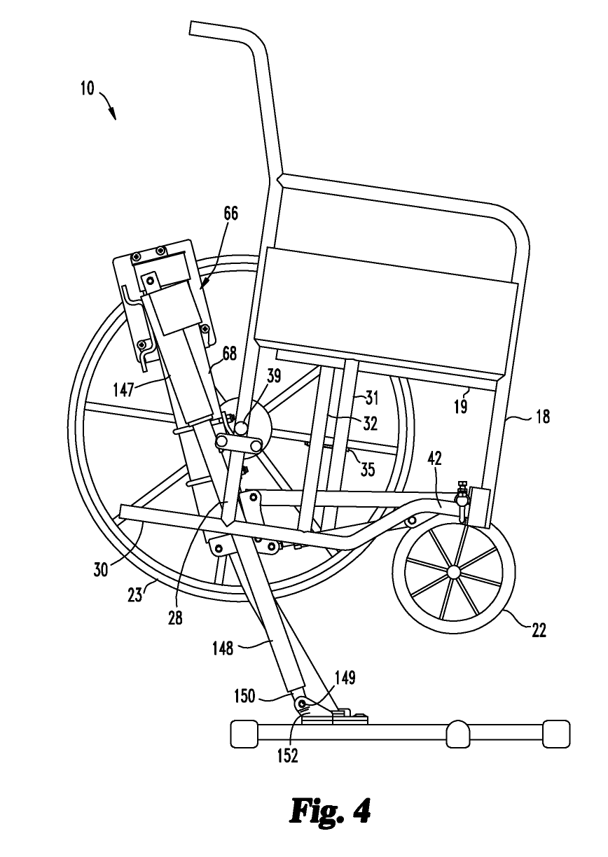

Referring to FIGS. 3 and 4, motive assembly 66 is a standard linear actuator 147 rigidly connected at its top to sleeve 67, and its output shaft 148 is pivotally connected via a pin 149 at its outboard end 150 to an upstanding flange 152 of mounting plate 73. Extension and retraction of linear actuator 147 thus moves sleeve 68 up and down relative to mooting plate 73, rod 68 and base 11, between its extended and retracted positions 76 and 75, respectively.

Power source 14 includes a battery unit 156 (FIG. 3) mounted to the side of sleeve 67. A charging unit (not shown) can be connected to battery unit 156 and plugged into an external power source, such as a standard 110V wall outlet, to both charge battery unit 156 and /or to run apparatus 10 directly. In one embodiment, battery unit 156 comprises a lead acid battery.

Referring to FIGS. 3, 6 and 7, chair connection assembly 13 includes front and rear connection assemblies 160 and 161, respectively. Front connection assembly 160 includes a front yoke assembly 163, a main support arm 164 and an adjustable buttress rod 165. Front yoke assembly 163 includes a central tube 167 and mirror image, left and right connection rods 168 and 169. Central tube 167 is rigidly fixed to the outboard end 170 of main support arm 164. Connection rod 168 includes a C-bolt 171 that extends through holes in connection rod 168 and is adjustably held thereby by nuts 174 and 175. A portion of the distal end (at 176) of connection rod 168 is flattened to allow nuts 174 and 175 to seat firmly against rod 168, and an arcuate portion of the distal end of connection rod 168 is formed on the opposing, underside thereof (at 177) to firmly receive and improve the clamping connection with a the horizontal portion 42 of a wheelchair (see FIG. 5). The extension of connection rod 168 is in and out of central tube is variable and can be fixed (and later adjusted or removed, as desired) by a set screw 178.

The proximal end of main support arm 164 is pivotally connected to and between bracket plates 120 and 121 by a pin 179. Adjustable buttress rod 165 includes a first rod 181 and a second rod 182, the forward end of which that is threadedly received within the rear end of first rod 181 to act as a turnbuckle. The forward end 183 of first rod 165 is pivotally connected to a bracket 184 extending downwardly form main support arm 164. The rear end of second rod 182 is pivotally connected to and between bracket plates 120 and 121 by a pin 187, the mounting at pin 187 being below the mounting of main support arm 164 at pin 179. By adjusting the axial length (at the threaded connection between first and second arms 181 and 182), the front yoke assembly 163 can be raised and lowered to accommodate connection to wheelchairs of varying sizes.

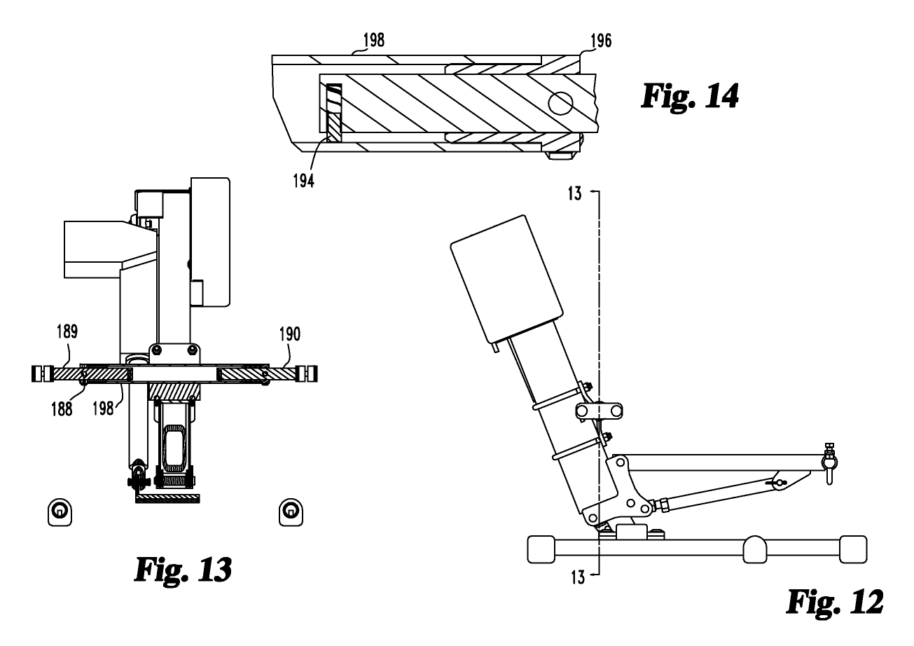

Referring to FIGS. 3 and 12-14, rear connection assembly 161 includes a rear yoke assembly 189 with extendable connection rods 189 and 190 that, like front yoke assembly 163 have set screws 188 to releasably fix the yoke arm width. The inboard ends of each of the rods 189 and 190 include spring biased pins 194 that, upon assembly, pop out and behind the inner end of its respective cap 196 that is fixed (as by welding) to the outer ends of the central tube 198 of rear yoke assembly 190. Connection rods 189 and 190 are thus telescopically adjustable within central tube 198, but prevented from being extended all the way out of and away from central tube 198 and its end caps 196 by pins 194. Central tube 198 is fixed as by welding to a mounting plate 199 that is adjustably mounted to sleeve 67 to thereby adjust the height or rear yoke assembly 189 relative to sleeve 67. At their outer ends, connection rods 189 and 190 have clamps 202 that clamp onto the vertical frame members 27 and 28 above or below the wheel axles 38 and 29, as appropriate.

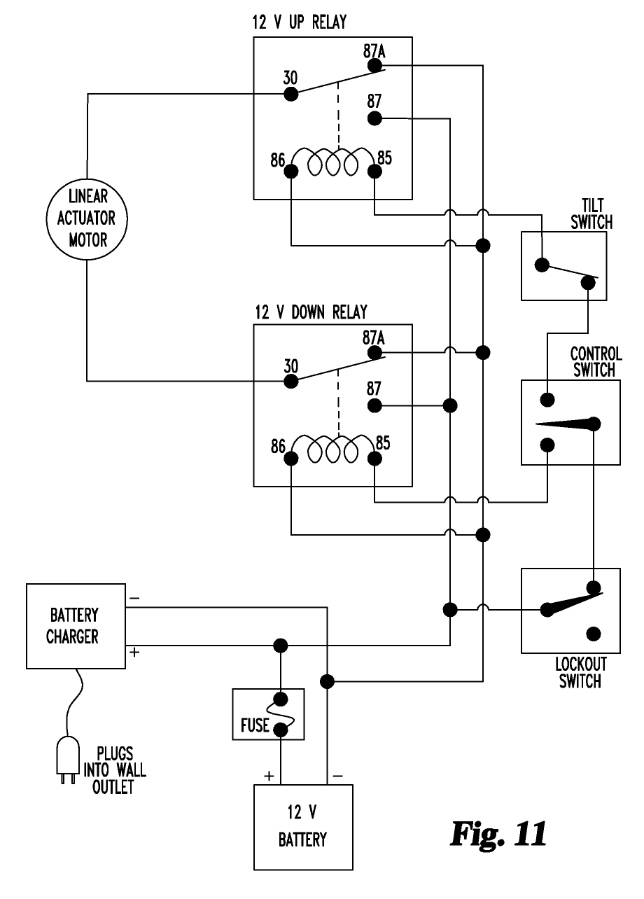

Lift control assembly 15 includes electronic circuitry, as shown in FIG. 11, that is connected in connection with the lift assembly 12, power source 14 and lift control assembly 15 to operate apparatus 10. Also included is a hand control device 204 connected with lift control assembly 15 to enable the chair occupant or care giver to operate the chair 5.

Apparatus 10 further includes a tilt sensor 200 (FIG. 5) that is connected to the electronic control mechanism of the lift control assembly, and operates to disable the lifting action of the apparatus 10 in the event base 11 is tilting beyond a set angle, in one embodiment, the set angle is 5 degrees. In another embodiment, the set angle is 4+/−1 degrees. Alternative embodiments are contemplated wherein this angle can be a different value or can be adjustable.

Upon connection to a wheelchair, the base 11 is configured so that rear feet 51 and 52 are positioned far to the rear, but not behind rear wheels 23 and 24 and are spaced so that feet 51 and 52 do not interfere or contact rear wheels 23 and 24, but far apart enough to enable a person to walk between feet 51 and 52. Also, feet 53 and 54 are positioned outwardly as far as possible, but laterally not beyond or not far beyond wheels 23 and 24; and arm 48 and its foot 55 are positioned farther forward than and midway between feet 53 and 54 so that the feet of a chair occupant can rest substantially unobstructed on either side of arm 48.

Rod 68 is here also a tube, but is contemplated have other configurations, such as solid, honeycomb, or any configuration or composition that satisfies the operation of apparatus 10.

Alternative embodiments are contemplated wherein different configurations for guide assembly 65 provide for different paths of movement between sleeve 67 and rod 68, such as purely linear motion.

Alternative embodiments are contemplated wherein the lift angle α defined, with apparatus 10 mounted with wheelchair 5 such that, in the retracted, down position 75, base 11 is inclined whereby the rear feet 51 and 52 about one inch from the ground, and the front feet are about two and one half inches above the ground. In one embodiment, the lift angle α is here about 64 degrees. In this embodiment, when the lift assembly 12 is extended, the rear feet 51 and 52 engage the ground first. Further extension of lift assembly 12 causes the wheelchair to start to tilt forward as the front feet 53-55 then approach and engage the ground. Once all feet 51-55 are engaged with ground, the wheelchair then rises and rocks (tilts) forward, as described herein.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. An apparatus for lifting a wheelchair, the wheelchair including a frame with first and second rear frame members and first and second front frame members, the apparatus comprising:
a ground-engageable base;
a chair connection assembly having connection means for securely connecting to the frame of a wheelchair;
a lift assembly having first and second lift members, the first lift member connected with said chair connection assembly and the second lift member connected to said base;
power means connected with said lift assembly for moving said lift assembly between a retracted, down position and an extended, up position; and
a lift control assembly for connecting said power means with said lift assembly and for controlling said lift assembly.

2. The apparatus for lifting a wheelchair of claim 1 wherein the first lift member moves relative to the second lift member in a non-linear path between the retracted, down position and an extended, up position.

3. The apparatus for lifting a wheelchair of claim 2 wherein the first lift member is a sleeve and the second lift member is a rod, an upper portion of which is received in the sleeve for mutual non-linear extension and retraction therewith.

4. The apparatus for lifting a wheelchair of claim 2 wherein said lift connection assembly further includes movement assist elements disposed between the first and second lift members for guiding the first and second lift member along their non-linear path.

5. The apparatus for lifting a wheelchair of claim 4 wherein the first lift member is a sleeve with an inner wall and a bottom end and the second lift member is a rod with an top end, an upper portion of the rod being received in the sleeve for mutual non-linear extension and retraction between the rod and sleeve.

6. The apparatus for lifting a wheelchair of claim 5 wherein the movement assist elements include a guide assembly connected to and proximal the top end of the rod, the guide assembly sized and configured to contact and follow the inner wall of the sleeve.

7. The apparatus for lifting a wheelchair of claim 6 wherein the guide assembly includes a guide member that is offset relative to the top end of the rod.

8. The apparatus for lifting a wheelchair of claim 7 wherein the guide member is a block having at least one side that is arcuate and positioned for pivotal contact with the inner wall of the sleeve during movement between the extended, up position and retracted, down position.

9. The apparatus for lifting a wheelchair of claim 5 wherein the movement assist elements include a lower guide assembly connected to and at the bottom end of the sleeve, the lower guide assembly configured to restrain movement of the rod in at least one direction during movement of the rod between the extended, up position and retracted, down position.

10. The apparatus for lifting a wheelchair of claim 9 wherein the lower guide assembly includes at least two rollers positioned on opposing front and rear sides of the rod.

11. The apparatus for lifting a wheelchair of claim 2 wherein the second lift member has a bottom end and is connected to said base at a rearwardly leaning lift angle α that is between about 53 and 67 degrees.

12. The apparatus for lifting a wheelchair of claim 11 wherein the lift angle α is about 60 degrees.

13. The apparatus for lifting a wheelchair of claim wherein the lift angle α is about 64 degrees.

14. The apparatus for lifting a wheelchair of claim 13 wherein said ground-engageagble base includes forward and rear feet and wherein, in the retracted, down position, said ground engaging base is inclined whereby the forward feet are higher than the rear feet.

15. The apparatus for lifting a wheelchair of claim 14 wherein, in the retracted, down position, the forward feet are about one and one half inches higher than the rear feet.

16. The apparatus for lifting a wheelchair of claim 11 wherein the wheelchair includes first and second rear wheels and first and second front wheels and wherein said ground-engageagble base includes first and second rear feet spaced apart and configured to engage ground proximal the wheelchair rear wheels.

17. The apparatus for lifting a wheelchair of claim 16 wherein said ground-engageagble base includes a central arm with a central front foot disposed between and forwardly of the forward feet.

18. A method for lifting a wheelchair, the wheelchair including a frame with first and second rear frame members and first and second front frame members, the method for lifting a wheelchair comprising the steps of:
providing an apparatus for lifting a wheelchair, the apparatus including:
a ground-engageable base,
a chair connection assembly having connection means for securely connecting to the frame of a wheelchair, the connection means including front and rear connection assemblies configured for adjustable connection to the first and second front frame members of the wheelchair and first and second rear frame members of the wheelchair, respectively,
a lift assembly having first and second lift members, the first lift member connected with said chair connection assembly and the second lift member connected to said base,
power means connected with said lift assembly for moving said lift assembly between a retracted, down position and an extended, up position, and
a lift control assembly for connecting said power means with said lift assembly and for controlling said lift assembly;
with said apparatus in the retracted, down position, positioning said apparatus under the wheelchair;
connecting the front connection assembly to the first and second front wheelchair frame members;
connecting the rear connection assembly to the first and second rear wheelchair frame members;
actuating said power means with said lift control assembly to move said lift assembly from the retracted, down position to the extended, up position.
